(19) United States
(12) Patent Application Publication
(10) Pub. No.: US 2013/0010451 A1
(43) Pub. Date: Jan. 10, 2013

(54) LASER DIODE MODULE

(75) Inventor: Kazushige MUKAIHARA, Kanagawa (JP)

(73) Assignee: RENESAS ELECTRONICS CORPORATION

(21) Appl. No.: 13/531,951

(22) Filed: Jun. 25, 2012

(30) Foreign Application Priority Data
Jul. 7, 2011 (JP) 2011-151052

(51) Int. Cl. F21V 13/02; F21V 13/12

(52) U.S. Cl. 362/19

(57) ABSTRACT

A laser diode module includes a laser diode, a Faraday rotator, and a polarizer. The laser diode outputs an output laser beam which is linearly polarized light and is placed in TE mode. The Faraday rotator is disposed on the optical axis of the output laser beam and rotates the polarization direction of incident light by 45°. The polarizer is disposed on the side adjacent to an optical fiber, of the Faraday rotator, and the direction of the transmission axis thereof agrees with the polarization direction of the output laser beam having passed through the Faraday rotator. No selection element configured to selectively transmit only a laser beam traveling in a particular polarization direction is disposed on the side adjacent to the laser diode, of the Faraday rotator.

### CROSS-REFERENCE TO RELATED APPLICATIONS

The disclosure of Japanese Patent Application Publication No. 2011-151052 filed on Jul. 7, 2011 including the specification, drawings and abstract is incorporated herein by reference in its entirety.

### BACKGROUND

The present invention relates to a laser diode module including an optical isolator.

Known laser diodes used for fiber-optic communications include distributed feedback laser diodes (DFB-LDs), which oscillate at a single wavelength. However, entry of reflected optical feedback into such a laser diode destabilizes the oscillation, causing an increase in relative intensity noise (RIN), or the like. As a result, the transmission characteristics are degraded. Generally used to control such degradation is an optical isolator. (For example, see Japanese Unexamined Patent Application Publication Nos. 2003-075679 and 2007-164009.)

FIG. 1 is a sectional view of an optical isolator-equipped receptacle described in Japanese Unexamined Patent Application Publication No. 2003-075679. An optical fiber 4 is held by holding fixtures, that is, a stub 3, a sleeve 5, and a fitting 8. An optical isolator device 7 is attached to an end surface of the stub 3. The optical isolator device 7 includes two polarizers, 1a and 1b, and a Faraday rotator 2 interposed between the polarizers 1a and 1b. The directions of the transmission axes of the polarizers 1a and 1b differ from each other by 45°. The Faraday rotator 2 rotates the polarization direction (polarization surface) of incident light in a given direction by 45°. A magnet 6 is fixed to an end surface of the fitting 8 as disposed around the optical isolator device 7.

FIG. 2 is a conceptual diagram showing functions of the optical isolator device 7. In FIG. 2, the direction along the optical axis is represented by a z direction. The direction of the transmission axis of the polarizer 1a, which is adjacent to the laser diode, is represented by an s direction, which is perpendicular to the z direction. On the other hand, the direction of the transmission axis of the polarizer 1b, which is adjacent to the optical fiber, is represented by a t direction, which is perpendicular to the z direction and forms an angle of 45° with the s direction. The direction perpendicular to both the z and s directions is represented by a u direction.

First, an output laser beam LO emitted by the laser diode passes through the polarizer 1a. The polarization direction of the output laser beam LO having passed through the polarizer 1a is the s direction. When the output laser beam LO passes through the Faraday rotator 2, the polarization direction thereof rotates from the s direction to the t direction by 45°. Subsequently, the output laser beam LO whose polarization direction has become the t direction passes through the polarizer 1b and then enters the optical fiber.

Meanwhile, the entry of the output laser beam LO into the optical fiber 40 causes Rayleigh scattering or reflection on the reflection point, such as an optical connector, generating optical feedback LR having random polarization. The optical feedback LR enters the optical isolator device 7 from the side thereof adjacent to the optical fiber. The polarization direction of the optical feedback LR having passed through the polarizer 1b is the t direction. Subsequent passage of the optical feedback LR through the Faraday rotator 2 rotates the polarization direction thereof from the t direction to the u direction by 45°. At this time, the polarization direction (u direction) is perpendicular to the direction of the transmission axis (s direction) of the polarizer 1a, which is adjacent to the laser diode. Accordingly, most of the optical feedback LR, whose polarization direction has become the u direction, does not pass through the polarizer 1a. That is, most of the optical feedback LR having random polarization is absorbed by the two polarizers, 1a and 1b, and thus does not reach the laser diode. This prevents unstable oscillation of the laser diode.

Japanese Unexamined Patent Application Publication No. 2008-176279 describes a bidirectional light receiving/emitting module including both a light-emitting element and a light-receiving element. Transmission signal light emitted by the light-emitting element enters an optical fiber. Reception signal light emitted by the optical fiber enters the light-receiving element. A wavelength selection filter is disposed in a position on the optical path between the light-emitting element and the optical fiber as well as on the optical path between the light-receiving element and the optical fiber. The bidirectional light receiving/emitting module also includes a reflective polarizer attached to an end surface of the optical fiber, a Faraday rotator disposed adjacent to the reflective polarizer, and an absorption polarizer disposed on the optical path between the light-emitting element and the wavelength selection filter. The reflective polarizer has a wavelength-dependent characteristic which allows it to function as a polarizer with respect to transmission signal light but does not allow it to function as a polarizer with respect to reception signal light.

### SUMMARY

As shown in FIG. 2, the optical isolator of the related art uses the two polarizers. However, near infrared polarizers generally used for fiber-optic communications are one of expensive components. Use of two polarizers in an optical isolator increases cost.

According to one aspect of the present invention, a laser diode module includes a laser diode, a Faraday rotator, and a polarizer. The laser diode outputs an output laser beam which is linearly polarized light and is placed in TE mode. The Faraday rotator is disposed on an optical axis of the output laser beam and configured to rotate the polarization direction of incident light by 45°. The polarizer is disposed on a side adjacent to an optical fiber, of the Faraday rotator, and the direction of the transmission axis thereof agrees with the polarization direction of the output laser beam having passed through the Faraday rotator. According to the aspect of the present invention, no selection element configured to selectively transmit only a laser beam traveling in a particular polarization direction is disposed on a side adjacent to the laser diode, of the Faraday rotator.

According to another aspect of the present invention, an optical isolator includes a Faraday rotator configured to rotate the polarization direction of incident light by 45° and a polarizer disposed on a side adjacent to an optical fiber, of the Faraday rotator. No selection element configured to selectively transmit only a laser beam traveling in a particular polarization direction is disposed on a side adjacent to a laser diode, of the Faraday rotator.

According to the aspects of the present invention, one polarizer is omitted compared to optical isolators of the related art. As a result, cost is reduced.

### BRIEF DESCRIPTION OF THE DRAWINGS

FIG. 1 is a sectional view of an optical isolator-equipped receptacle described in Japanese Unexamined Patent Application Publication No. 2003-075679;

FIG. 2 is a conceptual diagram showing functions of a typical optical isolator device;

FIG. 3 is a schematic diagram showing the configuration of a laser diode module according to an embodiment of the present invention;

FIG. 4 is a conceptual diagram showing the principle of the laser diode module according to this embodiment;

FIG. 5 is a graph showing the measured values of relative intensity noise related to the laser diode module according to this embodiment; and

FIG. 6 is a schematic diagram showing a modification of the laser diode module according to this embodiment.

### DETAILED DESCRIPTION

Now, an embodiment of the present invention will be described with reference to the accompanying drawings.

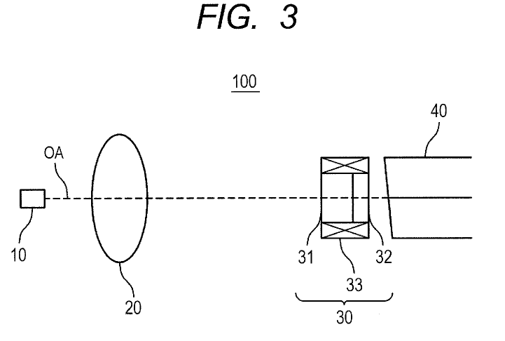

FIG. 3 is a schematic diagram showing the configuration of a laser diode module 100 according to an embodiment of the present invention. The laser diode module 100 is used for fiber-optic communications. As shown in FIG. 3, the laser diode module 100 includes a laser diode 10, a lens 20, an optical isolator 30, and an optical fiber 40. In an example shown in FIG. 3, the laser diode 10, the lens 20, the optical isolator 30, and the optical fiber 40 are disposed along the optical axis OA of a laser beam in this order.

In this embodiment, the laser diode 10 outputs a laser beam that is linearly polarized light and is placed in TE mode. In other words, an output laser beam of the laser diode 10 has a single TE polarization plane. The laser diode 10 is typically a quantum well laser having good monochromaticity. The laser diode 10 is, for example, a multiple quantum well (MQW) laser having a compressive strain quantum well active layer made of InGaAsP, AlGaInAs, or the like. This type of quantum well laser generally oscillates in TE mode owing to the difference in reflectance between TE and TM polarization on the light-emitting end surface or owing to the difference in gain between TE and TM modes of the active layer.

The optical isolator 30 includes a Faraday rotator 31, a polarizer 32, and a magnet 33. The Faraday rotator 31 and the polarizer 32 are disposed on the optical axis OA of a laser beam. The magnet 33 is disposed around the Faraday rotator 31. When the magnet 33 applies a magnetic field to the Faraday rotator 31, the Faraday rotator 31 exhibits the Faraday effect. The Faraday rotator 31 is formed so as to rotate the polarization direction (polarization surface) of incident light in a given direction by 45°.

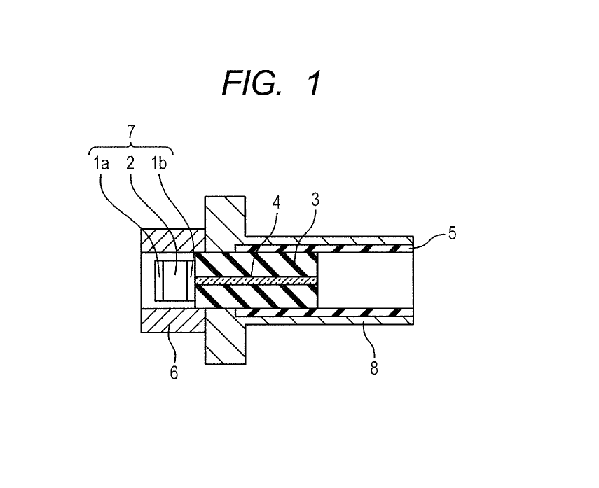

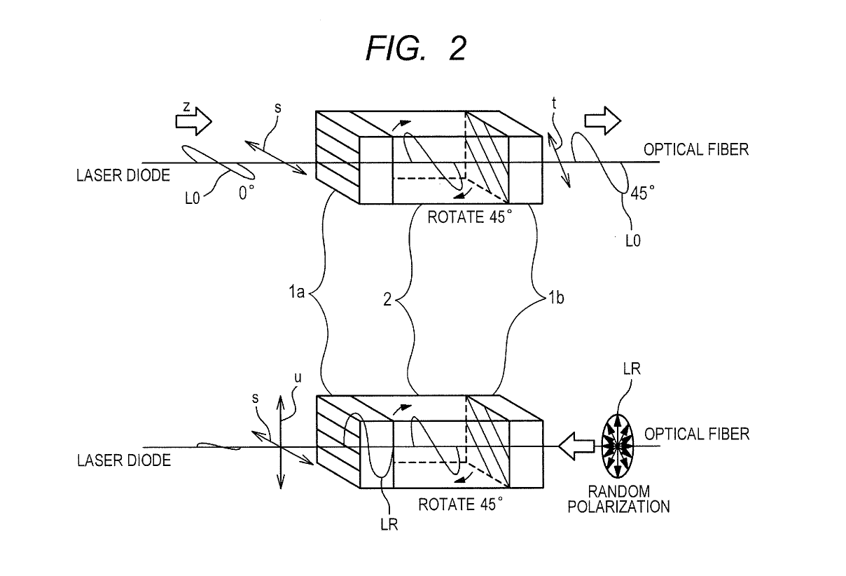

As shown in FIG. 3, the polarizer 32 is disposed on the side adjacent to the optical fiber 40, of the Faraday rotator 31. The polarizer 32 may be fixed to the edge adjacent to the optical fiber 40, of the Faraday rotator 31 or may be disposed adjacent to that edge. On the other hand, no polarizer is disposed on the side adjacent to the laser diode 10, of the Faraday rotator 31. This structure is equivalent to a structure where the polarizer 1a adjacent to the laser diode is excluded from the typical optical isolator shown in FIG. 1 or FIG. 2. In this case, an output laser beam outputted by the laser diode 10 directly enters the Faraday rotator 31 without passing through a polarizer.

Meanwhile, the wavelength selection filter described in Japanese Unexamined Patent Application Publication No. 2008-176279 performs a similar function to a polarizer. In this embodiment, such a wavelength selection filter is also not disposed on the side adjacent to the laser diode 10, of the Faraday rotator 31. More generally, a polarizer or wavelength selection filter can be said to be a “selection element” that selectively transmits only a laser beam travelling in a particular polarization direction. In this embodiment, such a selection element is not disposed on the side adjacent to the laser diode 10, of the Faraday rotator 31.

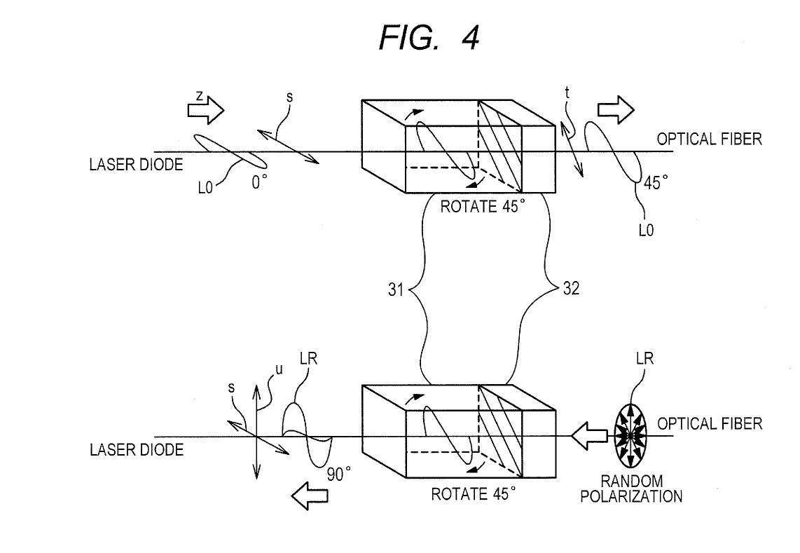

FIG. 4 is a conceptual diagram showing the principle of the laser diode module 100 according to this embodiment. In FIG. 4, the direction along the optical axis OA is represented by a z direction.

First, the laser diode 10 outputs an output laser beam LO which is linearly polarized light and is placed in TE mode. The polarization direction of the output laser beam LO is represented by an s direction, which is perpendicular to the z direction. The output laser beam LO outputted by the laser diode 10 enters the Faraday rotator 31 without passing through the above-mentioned selection element. When the output laser beam LO passes through the Faraday rotator 31, the polarization direction thereof rotates from the s direction to a t direction by 45°. The t direction is a direction that is perpendicular to the z direction and forms an angle of 45° with the s direction.

The polarizer 32 adjacent to the optical fiber 40 is disposed in such a manner that the direction of the transmission axis thereof is the t direction. In other words, the direction of the transmission axis of the polarizer 32 agrees with the polarization direction (t direction) of the output laser beam LO having passing through the Faraday rotator 31. Accordingly, the output laser beam LO, whose polarization direction has become the t direction, passes through the polarizer 32 and then enters the optical fiber 40.

The entry of the output laser beam LO into the optical fiber 40 causes Rayleigh scattering or reflection on the reflecting point, such as an optical connector, generating optical feedback LR having random polarization. The optical feedback LR enters the polarizer 32 from the side thereof adjacent to the optical fiber 40. The polarization direction of the optical feedback LR having passed through the polarizer 32 is the t direction. When the optical feedback LR passes through the Faraday rotator 31, the polarization direction thereof rotates from the t direction to a u direction by 45°. The u direction is a direction that is perpendicular to both the z direction and the s direction. The optical feedback LR emitted from the Faraday rotator 31 enters the active layer of the laser diode 10 without passing through the above-mentioned selection element.

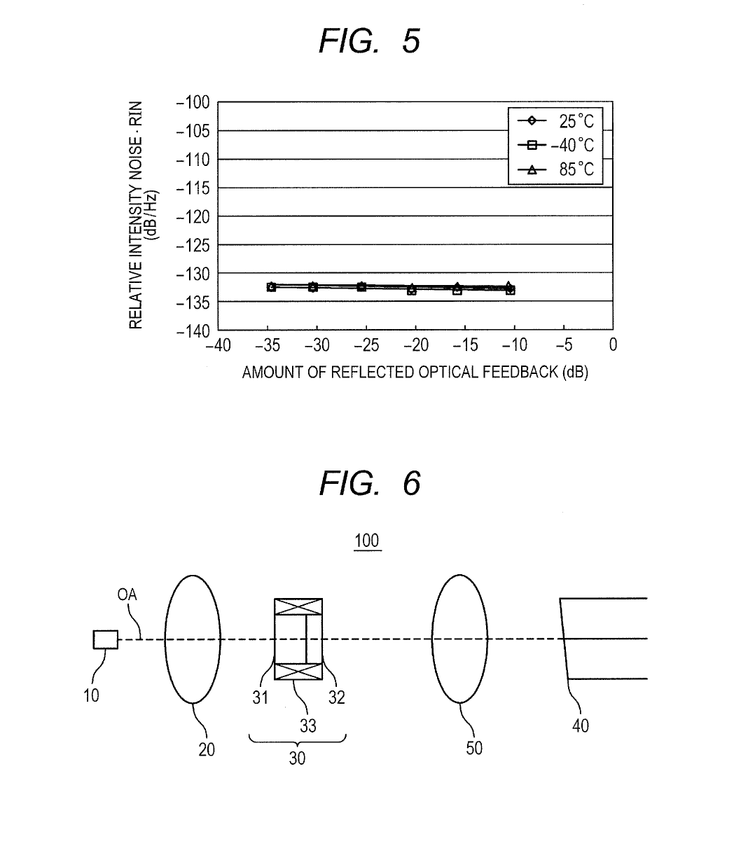

The polarization direction (u direction) of the optical feedback LR having entered the active layer of the laser diode 10 is perpendicular to the polarization direction (s direction) of the output laser beam LO emitted by the active layer of the laser diode 10. The inventors of this application have found that as long as this condition is met, the optical feedback LR does not affect the oscillation characteristics of the laser diode 10. The entry into the active layer, of the optical feedback LR having the same polarization direction as the TE-mode output laser beam LO disturbs the TE-mode oscillation characteristics. On the other hand, when the respective polarization directions of the output laser beam LO and the optical feedback LR are perpendicular to each other, the TE-mode oscillation characteristics are hardly affected. Data demonstrating this fact is shown in FIG. 5.

FIG. 5 shows the measured values of relative intensity noise (RIN) related to the laser diode module 100 according to this embodiment. In this experiment, a 1.31 μm DFB-LD module for 2.5 Gbps transmission having a structure according to this embodiment was used as the laser diode module 100. The amount of optical feedback to the laser diode module 100 was changed in the range of −34 to −11 dB, and the temperature was changed in the range of −40 to 85° C. From FIG. 5, it is understood that RIN was stable at about −132 dB/Hz in the evaluated entire range. That is, the variations in the amount of optical feedback did not affect the oscillation characteristics of the laser diode 10, keeping RIN stable at low levels.

As seen, according to this embodiment, the entry of part of the optical feedback LR from the optical fiber 40 into the active layer of the laser diode 10 does not affect the oscillation characteristics of the laser diode 10. The reason is that the polarization direction (u direction) of the optical feedback LR having entered the active layer of the laser diode 10 is perpendicular to the polarization direction (s direction) of the output laser beam LO emitted by the active layer of the laser diode 10. As long as this condition is met, there is no need to dispose a polarizer on the side adjacent to the laser diode 10, of the Faraday rotator 31. That is, one polarizer can be omitted compared to the typical optical isolator shown in FIG. 1 or FIG. 2. Since a polarizer is one of expensive components, cost is significantly reduced. According to this embodiment, it is possible to achieve stable communications having reduced RIN while reducing cost.

FIG. 6 shows a modification of this embodiment. In this modification, a lens 50 is disposed between the optical isolator 30 and the optical fiber 40. The other structure and operation are the same as the above-mentioned embodiment.

While the embodiment of the present invention has been described with reference to the accompanying drawing, the invention is not limited thereto. Various changes can be made thereto by those skilled in the art as appropriate without departing from the spirit and scope of the invention.

What is claimed is:

1. A laser diode module comprising:
a laser diode configured to output an output laser beam which is linearly polarized light and is placed in TE mode;
a Faraday rotator disposed on an optical axis of the output laser beam and configured to rotate the polarization direction of incident light by 45°; and
a polarizer disposed on a side adjacent to an optical fiber, of the Faraday rotator, the direction of the transmission axis of the polarizer agreeing with the polarization direction of the output laser beam having passed through the Faraday rotator,
wherein no selection element configured to selectively transmit only a laser beam traveling in a particular polarization direction is disposed on a side adjacent to the laser diode, of the Faraday rotator.

2. The laser diode module according to claim 1, wherein
the selection element is one of a polarizer and a wavelength selection filter.

3. An optical isolator comprising:
a Faraday rotator configured to rotate the polarization direction of incident light by 45°; and
a polarizer disposed on a side adjacent to an optical fiber, of the Faraday rotator, wherein
no selection element configured to selectively transmit only a laser beam traveling in a particular polarization direction is disposed on a side adjacent to a laser diode, of the Faraday rotator.
